(19) United States
(12) Patent Application Publication
(10) Pub. No.: US 2025/0332739 A1
(43) Pub. Date: Oct. 30, 2025

(54) VERSATILE PNEUMATIC END EFFECTOR

(71) Applicant: Shoushana Ohanessian, Glendale, CA (US)

(72) Inventor: Shoushana Ohanessian, Glendale, CA (US)

(21) Appl. No.: 19/191,132

(22) Filed: Apr. 28, 2025

Related U.S. Application Data
(60) Provisional application No. 63/639,337, filed on Apr. 26, 2024.

(51) Int. Cl. B25J 15/06

(52) U.S. Cl. CPC B25J 15/0616

(57) ABSTRACT

A versatile pneumatic end effector combines vacuum and mechanical gripping capabilities in a single integrated device. The end effector includes a base housing a motor and vacuum pump, with a vacuum gripper mounted to the top face and a two-finger gripper mechanism having height-adjustable fingertips. The fingertips are controlled by servo motors through pinion gears engaging gear racks to enable precise height adjustment between maximum height for mechanical gripping and minimum height for unobstructed vacuum operation. The two-finger mechanism comprises driving linkages connected to the motor, support linkages, and fingertip linkages containing the height adjustment system. The vacuum and mechanical gripping systems operate independently without interference, allowing seamless transitions between modes and simultaneous usage capabilities. The end effector eliminates the need for tool head changes while providing enhanced object manipulation through combined gripping modes. The system is adaptable for various robotic applications requiring efficient handling of diverse workpiece types and orientations.

### CROSS-REFERENCE TO RELATED APPLICATIONS

This application claims priority to U.S. Provisional Application No. 63/639,337, filed Apr. 26, 2024, entitled “Versatile Pneumatic End Effector System with Rotating Gripper Attachment for Enhanced Product Handling,” the specification of which is hereby incorporated by reference in its entirety.

### FIELD OF THE INVENTION

The present invention relates generally to robotic end effectors and automated manipulation systems used in manufacturing, assembly, and retail environments. More particularly, the invention relates to versatile end effector systems that can perform multiple types of object acquisition and manipulation tasks through combined vacuum and mechanical gripping capabilities. The invention has applications in automated assembly systems, precision manufacturing operations, and other environments requiring flexible and efficient robotic manipulation of diverse workpieces without human intervention. The field includes robotic tooling applications for picking, placing, and manipulating various objects and components in both industrial and commercial settings where operational efficiency and adaptability are essential.

### BACKGROUND OF THE INVENTION

In automated assembly and manufacturing environments, robots require different types of end effectors to accomplish various tasks. Current end effector systems typically employ either vacuum-type grippers using suction cups or bellows for vacuum acquisition, or mechanical grippers with opposing fingers that can be moved toward and away from each other to physically grasp objects.

A significant technical challenge in robotic automation is the need to change between different end effector types during operations. For example, a typical operation requires the robot to pick up a workpiece with one type of end effector, deliver it for processing, retract, change to a different end effector tool head, return to pick up the processed workpiece, retract again, change back to the original end effector, and repeat the cycle. This process requires multiple distinct movements, substantially limiting throughput and operational efficiency.

Some systems utilize dual-handed end effectors with two sets of identical gripping mechanisms to handle multiple workpieces. Other approaches combine vacuum and mechanical gripping through various configurations. Additional systems focus on mechanical gripping with removable fingers for different applications.

The technical challenges in the field are numerous. Extended cycle times result from tool head changes between operations. Robots experience significant idle time while waiting for workpiece processing. System complexity increases due to maintaining multiple end effector types. Current systems have limited ability to handle workpieces of varying shapes and orientations. Operational flexibility is reduced when systems are restricted to single gripping modes.

These technical challenges highlight the need for more versatile end effector systems that can seamlessly transition between different gripping modes while maintaining the ability to handle diverse workpiece geometries and orientations. Additionally, manufacturing environments require solutions that can improve operational efficiency through reduced tool changes while providing enhanced object manipulation capabilities.

### SUMMARY OF THE INVENTION

In accordance with certain aspects of an embodiment of the invention. a versatile pneumatic end effector is provided that combines vacuum and mechanical gripping capabilities in a single integrated device. In one aspect, the invention includes an end effector base housing both a motor and vacuum pump, with a vacuum gripper mounted to the top face and a two-finger gripper mechanism having height-adjustable fingertips.

A key aspect of the invention is the height-adjustable fingertip system, which enables true dual-mode operation through servo motor control. The fingertips can be precisely positioned between a maximum height for mechanical gripping operations and a minimum height that allows unobstructed vacuum gripper operation.

The two-finger gripper mechanism incorporates driving linkages connected to the motor, support linkages providing structural guidance, and fingertip linkages containing servo motors and gear mechanisms for height adjustment. This configuration allows independent operation of the vacuum and mechanical gripping systems without interference between modes.

Systems configured in accordance with aspects of the invention enable seamless transitions between operational modes through coordinated control of the fingertip height adjustment and gripper positioning. This capability eliminates the need for tool head changes during different operations while maintaining full functionality of both gripping modes.

In various embodiments, the end effector can be incorporated into any type of robotic environment for pick and place operations. The system's ability to simultaneously use both gripping modes enhances object manipulation capabilities and increases possible object orientations and types that can be handled.

Systems configured in accordance with certain aspects of the invention may provide significant operational advantages through several key features. The system eliminates the need for end effector tool head changes. It enables independent operation of vacuum and mechanical gripping systems. The height-adjustable fingertips enhance workpiece manipulation capabilities. The system allows for simultaneous usage of both gripping modes. Furthermore, the end effector maintains compatibility with various robot arm manipulators.

### DETAILED DESCRIPTION OF THE DRAWINGS

The numerous advantages of the present invention may be better understood by those skilled in the art by reference to the accompanying drawings in which:

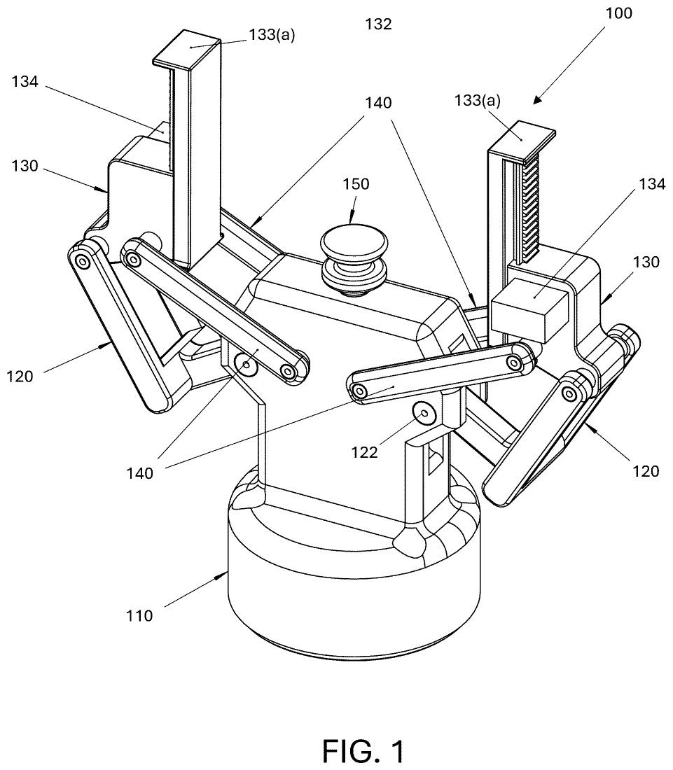

FIG. 1 shows a perspective view of a pneumatic end effector according to certain aspects of an embodiment of the invention.

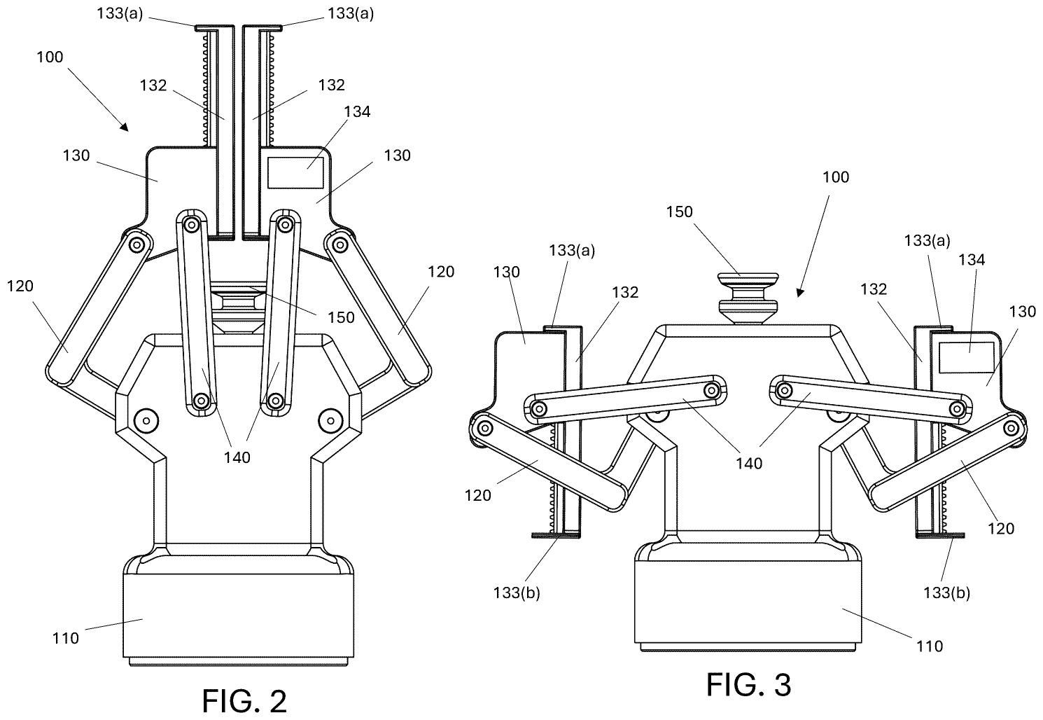

FIG. 2 shows a front view of the pneumatic end effector of FIG. 1 in a two-finger gripper operation configuration.

FIG. 3 shows a front view of the pneumatic end effector of FIG. 1 in a vacuum gripper operation configuration.

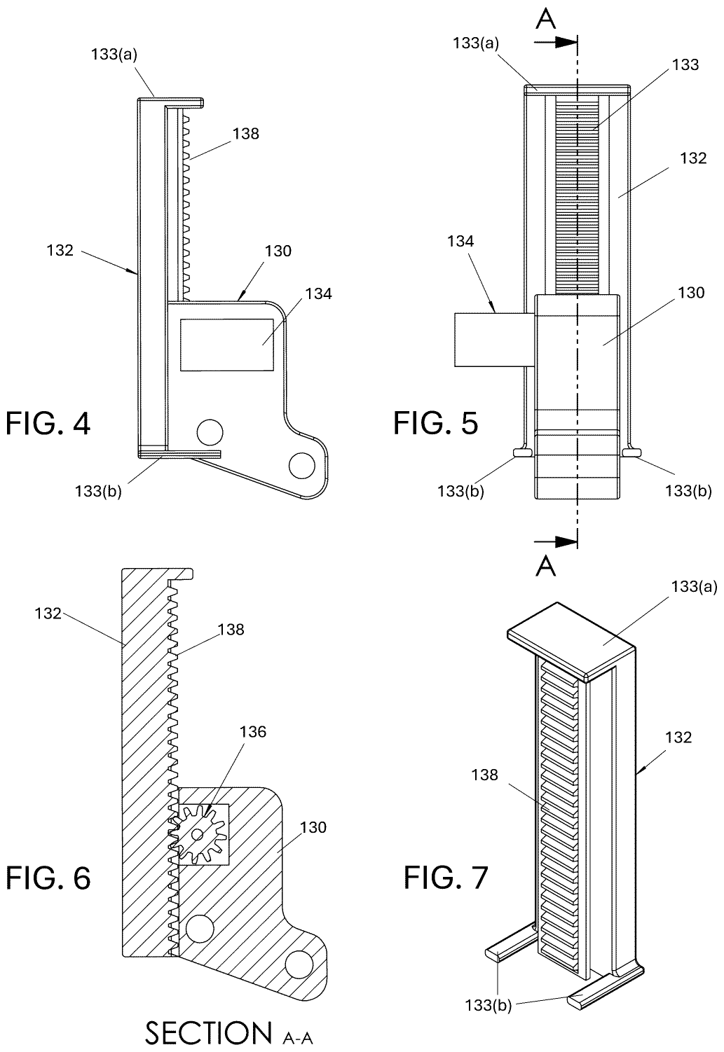

FIG. 4 shows a detail side view of a fingertip linkage for use in the pneumatic end effector of FIG. 1.

FIG. 5 shows a detail front view of the fingertip linkage of FIG. 4.

FIG. 6 shows a cross-sectional view of the fingertip linkage of FIGS. 3 and 4 along section line A-A.

FIG. 7 shows a detail perspective view of a height-adjustable fingertip for use with the fingertip linkage of FIGS. 3 and 4.

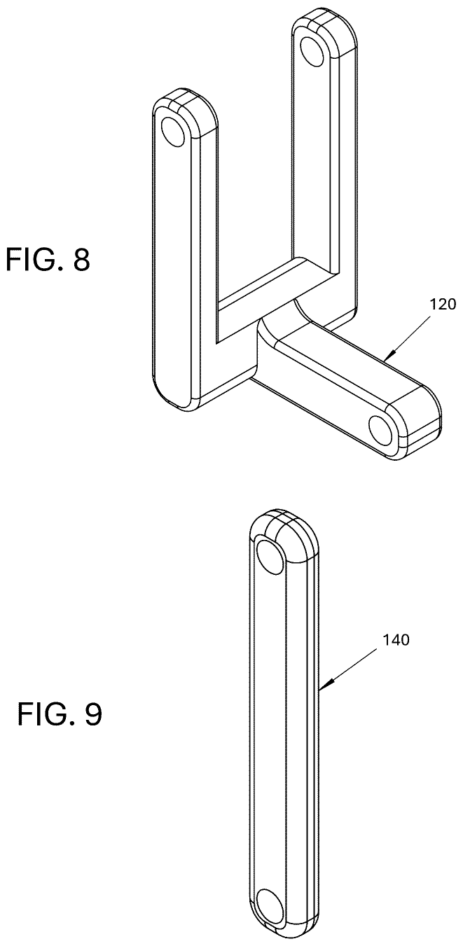

FIG. 8 shows a detail perspective view of a driving linkage for use in the pneumatic end effector of FIG. 1.

FIG. 9 shows a detail perspective view of a support linkage for use in the pneumatic end effector of FIG. 1.

### DETAILED DESCRIPTION

The invention summarized above may be better understood by referring to the following description, claims, and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced items.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

In accordance with certain aspects of a particularly preferred embodiment, FIG. 1 shows a full assembly view of an end effector 100 having a base 110 that comprises a cylindrical base with a rectangular protrusion that houses both a motor for driving the two-finger mechanical gripper mechanism and a vacuum pump for operating the vacuum gripper mechanism, both of which are further detailed below. The components can be sourced commercially off the shelf or self-fabricated to allow for flexible manufacturing and customization. This integrated design enables both mechanical and vacuum gripping modes to function within a single compact unit.

With reference generally to FIGS. 1-9, the motor inside of base 110 engages generally V-shaped driving linkages 120 that are mounted at driving linkage mounting pivots 122 on base 110 for pivotable movement with respect to base 110. Each driving linkage 120 carries a fingertip linkage 130, which fingertip linkage 130 in turn carries an integrated height-adjustable fingertip 132 configured for mechanically grasping an item that it to be manipulated by end effector 100. Support linkages 140 with rounded rectangular shapes are pivotably mounted at a first end to the outer body of base 110, and at a second end to fingertip linkage 130, such that each height-adjustable fingertip 132 is maintained in a vertical orientation (i.e., parallel to a height dimension of the base 110) throughout movement of each fingertip linkage 130. Each fingertip linkage 130 likewise includes a servo motor 134 mounted within the housing of fingertip linkage 130 that engages its respective height-adjustable fingertip 132 for vertical movement with respect to fingertip linkage 130. More particularly and as shown in FIG. 6, servo motor 134 drives a pinion gear 136 that, in turn, engages a gear rack 138 integrated on the respective height-adjustable fingertip 132 for precise linear motion for height adjustment of the height-adjustable fingertip 132. Each height-adjustable fingertip may include a top protrusion 133(a) and a bottom protrusion 133(b) for defining movement limits of the fingertip 132. Top protrusions 133(a) and bottom protrusion 133(b) create movement constraints that serve as physical movement endpoint boundaries. Bottom protrusion 133(b) contacts or nearly contacts the axile connecting support linkages 140 what at maximum height. Likewise, top protrusions 133(a) align with or position below the top face of fingertip linkage 130 at minimum height.

The vacuum gripper consists of a suction cup 150 mounted on the top face of the end effector base 110, which suction cup 150 is operatively connected to the vacuum pump inside of base 110 to enable vacuum engagement with an item that is to be manipulated by end effector 100. Unlike prior art devices requiring mechanical compression, this dedicated vacuum system operates independently of the mechanical gripping mechanism.

With this configuration and with particular reference to FIG. 2, end effector 100 may be placed into a two-finger gripper operation configuration with height-adjustable fingertips 132 maximally extended and enabling operation of end effector 100 to mechanically engage and grip items intended to be manipulated by end effector 100. In this configuration, the height-adjustable fingertips 132 are positioned at maximum height with the bottom protrusions 133(b) near axle connection points, allowing the fingertips 132 to fully extend for mechanical gripping and enabling direct object manipulation through finger movement.

Likewise with this configuration and with particular reference to FIG. 3, end effector 100 may be placed into a vacuum gripper operation configuration enabling operation of end effector 100 to engage items intended to be manipulated by end effector 100 via suction. In this vacuum gripper operation configuration, the height-adjustable fingertips 132 are retracted to their minimum height position, with the top protrusions 133(a) level with or positioned below the top face of end effector base 110, with fingertips 132 fully retracted below the vacuum gripper 150 workspace allowing unobstructed access of suction cup 150 to an item that is to be manipulated by vacuum gripping operations.

The height adjustment control system provides comprehensive positioning capability. The servo motors 134 deliver precise positional control. Rotation of pinion gear 136 drives linear movement of fingertip 132. The system 100 enables smooth transitions between operational heights while allowing positioning at variable heights between maximum and minimum positions.

End effector 100 transitions between the two-finger gripper operational mode and the vacuum gripper operation mode through carefully sequenced control of multiple components. When transitioning from two-finger gripper to vacuum gripper operation, the process begins with initial position setup. The two-finger gripper mechanism starts in two-finger gripper operation configuration with fingertips 132 at maximum height, where bottom protrusions 133(b) contact or nearly contact the axle connecting support linkages 140.

The gripper position then adjusts as the two-finger gripper mechanism moves to vacuum gripper operation position while fingertips 132 maintain maximum height during movement. Retraction of fingertips 132 follows as servo motors 134 activate to drive pinion gears 136 which engage with gear racks 138 on fingertips 132. Fingertips 132 retract to minimum height where top protrusions 133(a) level with or position below the top face of base 110 of end effector 100. Finally, the vacuum system activates as the vacuum pump generates vacuum within suction cup 150, making it ready for workpiece engagement.

For transitioning from vacuum gripper to two-finger gripper operation, the sequence begins with extension of fingertips 132. Servo motors 134 activate to drive pinion gears 136 in reverse direction, extending fingertips 132 to maximum height as bottom protrusions 133(b) approach axle connection points. The gripper position then adjusts, but only after fingertips 132 reach maximum height, as linkages begin moving to their two-finger gripper operation position. The configuration of system 100 completes with fingertips 132 positioned for mechanical gripping and the vacuum system available for deactivation as needed.

Preferably, end effector 100 is likewise configured to enable unique simultaneous usage of vacuum and mechanical gripping modes, providing enhanced manipulation capabilities beyond prior art systems. The combination of both end effector types in a single unit allows simultaneous usage during object manipulation, increasing possible object orientations and types that can be handled compared to single-mode end effectors.

Systems configured in accordance with aspects of the invention thus provide significant operational flexibility. The height-adjustable fingertips 132 can maintain various positions while the vacuum gripper engages, allowing supplementary mechanical support or guidance during vacuum-based operations. The two-finger gripper mechanism provides lateral stability while the vacuum gripper maintains primary workpiece engagement.

The options provided by such configuration expand operational capabilities. The fingertips 132 can partially retract to work alongside the vacuum gripper while still providing mechanical support. The independent operation of both systems enables dynamic adjustment of the mechanical gripper position during vacuum-based operations.

Those skilled in the art will recognize that end effector 100 may accommodate various modifications for enhanced versatility without departing from the scope of the invention. The design can incorporate different combinations of end effector types beyond the current vacuum and two-finger gripper combination. The system can adapt to enhance compatibility with various robot arm manipulators through modular connection interfaces.

The height-adjustable fingertips 132 can incorporate different geometries optimized for specific object types. The system can accommodate various height ranges for different applications. Alternative protrusion designs can serve different physical endpoint boundaries.

The system enables enhanced object manipulation through several adaptations. It allows simultaneous usage of both end effector types in different combinations for enhanced product handling. The design accommodates more possible object types or orientations through varied fingertip heights. Different operational capabilities emerge through varying fingertip configurations.

The robot arm integration capabilities extend to various applications. The end effector incorporates into any environment for pick and place operations. The system adapts for use with different robot arm manipulators. The design allows modification to operate without human intervention in various automated settings.

Manufacturing variations provide additional flexibility. Components can be sourced commercially off the shelf for standard configurations. The system allows self-fabrication for custom applications. Materials can be modified based on specific requirements.

A pneumatic end effector 100 configured in accordance with aspects of the invention may deliver substantial technical benefits compared to prior art systems. The system eliminates tool changes by removing the need to swap between different end effector tool heads during operations. This reduces the number of required robot movements for typical pick-and-place operations while minimizing robot idle time during workpiece processing.

The system likewise enables seamless mode transitions through direct switching between vacuum and mechanical gripping via coordinated height adjustment. This allows continuous operation without interruption for tool changes while providing capability for simultaneous usage of both gripping modes.

Enhanced workpiece handling versatility manifests through multi-mode gripping capabilities. The system combines vacuum and mechanical gripping in a single compact end effector. This enables handling of diverse object types through different gripping modes while allowing simultaneous usage of both gripping modes for complex manipulations.

The adaptable gripping configurations expand operational capabilities. The height-adjustable fingertips accommodate various object orientations. The system enables more possible object types and orientations compared to fixed-finger designs. The design provides enhanced positioning flexibility through variable fingertip heights.

Universal application extends the system's utility. The end effector incorporates into any environment for pick-and-place operations. The system maintains compatibility with various robot arm manipulators. The design suits diverse retail consumer applications.

The system's compact integration also provides significant design advantages. The base houses both vacuum pump and mechanical drive systems in a single unit. This eliminates the need for separate end effector storage and changing mechanisms. The system operates more efficiently than prior art systems requiring multiple tool heads.

Independent operation further enhances system capabilities. The vacuum and mechanical systems operate without interference. Unlike prior art systems requiring mechanical compression for vacuum operation, this design enables true dual-mode functionality without compromising either mode.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. A robotic end effector comprising:
a base housing a motor and a vacuum pump;
a vacuum gripper mounted to a top face of the base and connected to the vacuum pump; and
a two-finger gripper mechanism comprising:
first and second fingers, each finger comprising:
a driving linkage connected to the motor;
support linkages connected to the driving linkage; and
a fingertip linkage comprising a height-adjustable fingertip and a servo motor for adjusting the height of the fingertip;
wherein the height-adjustable fingertips are movable between:
a maximum height position for mechanical gripping operations, and
a minimum height position below the vacuum gripper for vacuum gripping operations.

2. The robotic end effector of claim 1, wherein each fingertip comprises top and bottom protrusions forming physical endpoint boundaries during height adjustment.

3. The robotic end effector of claim 1, wherein each fingertip linkage comprises:
a servo motor;
a pinion gear attached to the servo motor shaft; and
a gear rack within the fingertip that engages with the pinion gear.

4. The robotic end effector of claim 1, wherein:
the driving linkage has a “V” shape;
the support linkages have a rounded rectangular shape.

5. The robotic end effector of claim 1, wherein the vacuum gripper and two-finger gripper mechanism are operable simultaneously.

6. A method of operating a robotic end effector comprising:
providing an end effector having a vacuum gripper and a two-finger gripper with height-adjustable fingertips; and
transitioning between operational modes by:
moving the fingertips to maximum height for mechanical gripping operations; and
retracting the fingertips to minimum height below the vacuum gripper for vacuum gripping operations;
wherein the vacuum gripper and two-finger gripper are configured to operate independently without mechanical interference.

7. The method of claim 6, further comprising operating the vacuum gripper while the fingertips are partially retracted to provide simultaneous vacuum and mechanical gripping.

8. The method of claim 6, further comprising transitioning from mechanical to vacuum gripping by:
moving the two-finger mechanism to a vacuum operation position while fingertips are at maximum height; and
retracting the fingertips to minimum height.

9. The method of claim 6, wherein the fingertips are controlled by servo motors engaging pinion gears with gear racks in the fingertips.

10. The method of claim 6, wherein the end effector is configurable for different retail consumer applications.

11. A robotic end effector system comprising:
a base configured for connection to a robot arm;
a vacuum system comprising:
a vacuum pump housed in the base; and
a suction cup mounted to a top face of the base;
a mechanical gripping system comprising:
two fingers, wherein each finger has a height-adjustable fingertip;
servo motors for controlling fingertip height; and
linkages for moving the fingers toward and away from each other;
wherein the vacuum system and mechanical gripping system are operable simultaneously and independently.

12. The system of claim 11, wherein the mechanical gripping system provides lateral support during vacuum gripping operations.

13. The system of claim 11, wherein the fingertips are positionable at variable heights between maximum and minimum positions.

14. The system of claim 11, wherein the system is adaptable for use with different robot arm manipulators.

15. The system of claim 11, wherein the system is configured for vacuum and mechanical gripping.
